(19) United States
(12) Patent Application Publication
(10) Pub. No.: US 2006/0017871 A1
(43) Pub. Date: Jan. 26, 2006

(54) Liquid crystal display

(75) Inventors: Hirokazu Morimoto, Fukaya-shi (JP); Masaki Kinoshita, Saku-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA MATSUSHITA DISPLAY TECHNOLOGY CO., LTD., TOKYO (JP)

(21) Appl. No.: 11/176,393

(22) Filed: Jul. 8, 2005

(30) Foreign Application Priority Data
Jul. 21, 2004 (JP) 2004-213268

(51) Int. Cl. G02F 1/1335

(52) U.S. Cl. 349/114

(57) ABSTRACT

A liquid crystal display (1) includes an array substrate (11), a liquid crystal layer (12), and a counter substrate (13). The array substrate has optical sensors (1112) to detect light from an object presented in front of the array substrate. The counter electrode has a color filter (132) to transmit light emitted from a light source (14), a transparent electrode (134a) that faces a first plurality of pixel electrodes (113) and transmits the light transmitted through the color filter, and a reflective electrode (135) that faces a second plurality of pixel electrodes (113) and reflects external light. The light from the object to be detected is directly given to the optical sensors, which can therefore correctly detect the object. The light emitted from the light source and transmitted through the transparent electrode and the external light reflected from the reflective electrode realize transmissive display and reflective display.

### CROSS-REFERENCE TO RELATED APPLICATION

This application is based upon and claims the benefit of priority from the prior Japanese Patent Application No. 2004-213268, filed on Jul. 21, 2004. The entire contents of which are incorporated herein by reference.

### BACKGROUND OF THE INVENTION

1. Field of the Invention

The present invention relates to a liquid crystal display capable of correctly detecting an object and conducting transmissive display as well as reflective display.

2. Description of Related Art

Liquid crystal displays (LCDs) are thin, lightweight, and low in power consumption, and therefore, are widely used for cellular phones, smart-phones, PDAs (personal digital assistants), personal computers, and the like.

The LCD has an array substrate on which scanning lines and signal lines cross each other, a counter substrate, a liquid crystal layer held between the array substrate and the counter substrate, and a drive circuit for driving the scanning lines and the signal lines. A pixel is formed at each crossing portion of the scanning lines and the signal lines. A video signal is applied to the pixels, to change the light transmittance of the liquid crystal layer and display an image.

Among LCDs, those having light sources are in the mainstream because they can display images in the dark.

To make the LCD compact and low in cost, recent technology integrates the drive circuit into the array substrate containing pixels, each pixel having a switching element (such as a TFT (thin film transistor)) and a pixel electrode.

Some recent LCDs incorporate detective elements such as optical sensors to realize a scanning function.

The LCD having the scanning function emits light from a light source. The light is transmitted through the LCD and is reflected from a detection object such as a printed object. The intensity of the reflected light is detected by the optical sensors of the LCD and is used to provide an image of the object.

The optical sensors incorporated in the LCD may detect the intensity of light emitted from a light pen, to realize a light-pen input function. Instead of the optical sensors, other elements such as piezoelectric elements may be employed to realize a touch-panel function.

The detective elements such as the optical sensors and piezoelectric elements are formed on the array substrate so that the detective elements and TFTs serving as switching elements may be formed through common processes. This can reduce the number of manufacturing processes of the LCD. The light source is arranged behind the counter substrate of the LCD. This arrangement allows a detection object to be presented in front of the array substrate so that the detective elements may correctly detect light or pressure provided by the object.

To reduce power consumption, some recent LCDs conduct as a transmissive display with light emitted from a light source and also as a reflective display with external light to display, for example, the date and time. Such LCDs employ reflective electrodes for some pixel electrodes arranged on the array substrate.

There is a requirement for an LCD that is capable of providing the detective function and the transmissive-reflective display function.

Simply combining the structures of the two types of LCD by forming detective elements and reflective electrodes on an array substrate is unsatisfactory because the combination will transmit no external light through a liquid crystal layer. Then, the LCD is unable to control brightness and achieve reflective display.

An example of the related arts mentioned above is disclosed in Japanese Unexamined Patent Application Publication No. 2002-303863.

### SUMMARY OF THE INVENTION

An object of the present invention is to provide a liquid crystal display (LCD) capable of correctly detecting a detection object and conducting transmissive display as well as reflective display.

In order to accomplish the object, a first aspect of the present invention provides an LCD having an array substrate provided with a plurality of scanning lines and a plurality of signal lines that cross the scanning lines, a counter substrate, and a liquid crystal layer held between the array substrate and the counter substrate. A pixel is formed at each crossing portion of the scanning lines and the signal lines. The array substrate includes transparent pixel electrodes and detective elements. The pixel electrodes are provided for the pixels, respectively, to apply an electric field to the liquid crystal layer. The detective elements detect an object presented in front of the array substrate. The counter substrate includes a color filter to transmit light emitted from a light source that is arranged behind the counter substrate, a transparent electrode facing a first plurality of the pixel electrodes, to transmit the light transmitted through the color filter, and a reflective electrode facing a second plurality of the pixel electrodes, to reflect external light.

According to the first aspect, the array substrate of the LCD has the detective elements to detect an object presented in front of the array substrate. The counter substrate has the color filter that faces the first plurality of pixel electrodes and transmits light emitted from the light source, and the reflective electrode that faces the second plurality of pixel electrodes and reflects external light. The detection object is directly presented to the detective elements, so that the detective elements correctly detect the object. The light emitted from the light source and transmitted through the transparent electrode and the external light reflected from the reflective electrode are both transmitted through the liquid crystal layer, to thereby realize transmissive display as well as reflective display.

According to a second aspect of the present invention, the reflective electrode of the LCD of the first aspect has irregularities.

According to the second aspect, the reflective electrode of the LCD has irregularities to scatter light reflected from the reflective electrode, to increase the view angle.

According to a third aspect of the present invention, the reflective electrode of the LCD of any one of the first and second aspects is arranged on the liquid crystal layer side of the color filter.

According to the third aspect, the reflective electrode of the LCD is arranged on the liquid crystal layer side of the color filter, so that no external light is transmitted through the color filter under the reflective electrode, to thereby realize monochromatic reflective display.

In this way, the LCD according to the present invention includes the array substrate having the detective elements to detect an object presented in front of the array substrate. The counter electrode of the LCD includes the color filter to transmit light emitted from the light source, the transparent electrode that faces the first plurality of pixel electrodes and transmits the light transmitted through the color filter, and the reflective electrode that faces the second plurality of pixel electrodes and reflects external light. The detection object is directly presented to the detective elements, so that the detective elements may correctly detect the object. The light emitted from the light source and transmitted through the transparent electrode and the external light reflected from the reflective electrode are both transmitted through the liquid crystal layer, to thereby realize transmissive display as well as reflective display.

### BRIEF DESCRIPTION OF THE DRAWINGS

FIG. 1 is a sectional view partly showing an LCD 1 according to an embodiment of the present invention;

FIGS. 2A to 2J are sectional views showing, in particular, an optical sensor 1112 in a series of processes for forming the optical sensor 1112, an n-channel TFT 100, and a p-channel TFT 200 on an array substrate 11;

FIGS. 3A to 3J are sectional views showing, in particular, the n-channel TFT 100 in the series of forming processes;

FIGS. 4A to 4J are sectional views showing, in particular, the p-channel TFT 200 in the series of forming processes; and

FIG. 5 is a sectional view similar to FIG. 1, showing a detective operation of the LCD 1.

### DETAILED DESCRIPTION OF EMBODIMENT

A liquid crystal display (LCD) according to an embodiment of the present invention will be explained.

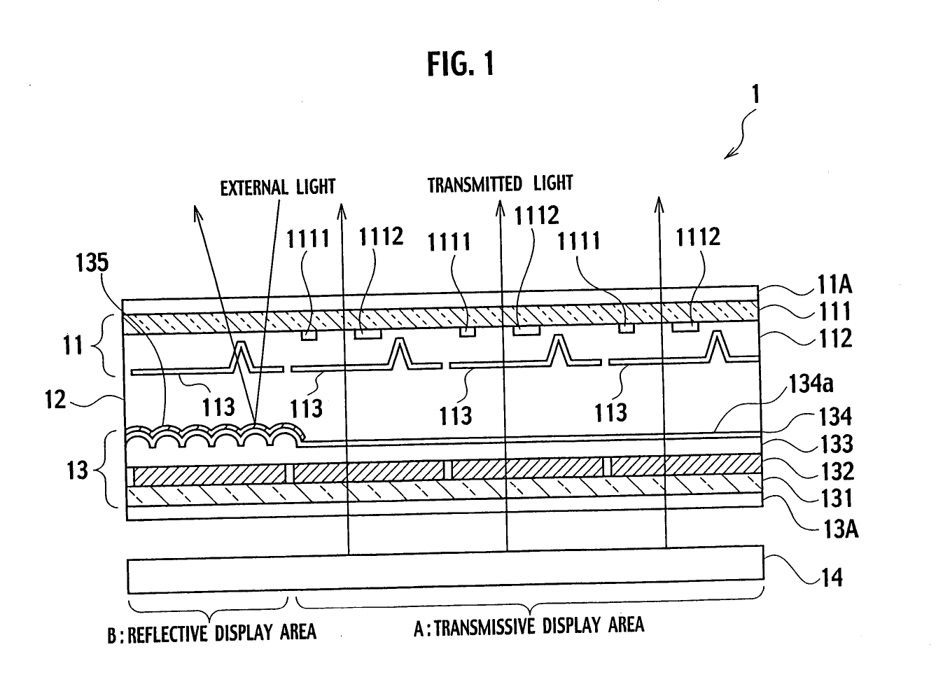

FIG. 1 is a sectional view partly showing the LCD 1 according to an embodiment of the present invention.

The LCD 1 has an array substrate 11 on which a plurality of scanning lines (not shown) and a plurality of signal lines (not shown) are formed. The scanning lines and the signal lines cross each other. The array substrate 11 faces a counter substrate 13, and a liquid crystal layer 12 is held between the array substrate 11 and the counter substrate 13.

In the LCD 1, red (R), green (G), and blue (B) pixels are regularly arranged at crossing portions of the scanning lines and the signal lines, respectively. An image displayed with the pixels is viewed in front of the array substrate 11. Behind the counter substrate 13, there is a surface light source 14.

The number of the signal lines is, for example, 240 for each of the R, G, and B colors. The number of the scanning lines is, for example, 320. Then, the number of pixels formed at the crossing portions of the signal and scanning lines will be about 230,000 to realize a QVGA (quarter video graphics array) display. All pixels may be arranged in a display area having a 2.2-inch diagonal size. With this size, a pixel pitch in a horizontal scanning direction is about 50 μm, a pixel pitch in a vertical scanning direction is about 150 μm, and a distance (cell gap) between the array substrate 11 and the counter substrate 13 is about 5 μm.

The LCD 1 has a transmissive display area A that allows light from the light source 14 to be transmitted through the liquid crystal layer 12 and a reflective display area B that reflects external light. The transmissive display area A may involve a majority of the pixels of the whole display area, and the reflective display area B involves the remaining pixels.

The array substrate 11 has a transparent glass substrate 111 of, for example, 0.7 mm thick. Each pixel region of the glass substrate 111 includes a switching element 1111 connected to a signal line (not shown) and a scanning line (not shown). On the liquid crystal layer 12 side of the glass substrate 111, there is a transparent resin layer 112 through which each switching element 1111 is connected to a transparent pixel electrode 113 made of, for example, ITO (indium tin oxide). The signal lines are connected to a signal line driver (not shown), and the scanning lines are connected to a scanning line driver (not shown).

Each pixel region in the transparent display area A of the array substrate 11 has an optical sensor 1112 that is connected to a detective circuit (not shown).

The counter substrate 13 has a glass substrate 131. The whole display area of the glass substrate 131 on the liquid crystal layer 12 side is covered with a color filter 132.

The color filter 132 is provided with a lattice-like light shield film made of resin. The color filter 132 of a specific color is arranged in each pixel region encircled by the signal lines and the scanning lines.

The whole display area of the color filter 132 of the counter substrate 13 is covered with a transparent resin layer 133. In the transparent display area A, the transparent resin layer 133 is flat, and in the reflective display area B, it is irregular.

The whole display area of the transparent resin layer 133 is covered with a transparent electrode 134 made of, for example, ITO. Corresponding to the shape of the transparent resin layer 133, the electrode 134 has irregularities in the reflective display area B.

The reflective display area B on the transparent electrode 134 is covered with an opaque reflective electrode 135 made of, for example, aluminum, to reflect external light. Corresponding to the irregular shape of the electrode 134, the reflective electrode 135 has irregularities.

The transparent display area A on the transparent electrode 134 serves as a transparent electrode 134a that is flat.

The transparent electrode 134a and reflective electrode 135 are covered with an orientation film that has been rubbed to provide the liquid crystal layer 12 with a pre-tilt of, for example, 6° in a predetermined direction.

On the light source 14 side, the counter substrate 13 has a polarizing plate 13A. On the front side of the array substrate 11, there is a polarizing plate 11A.

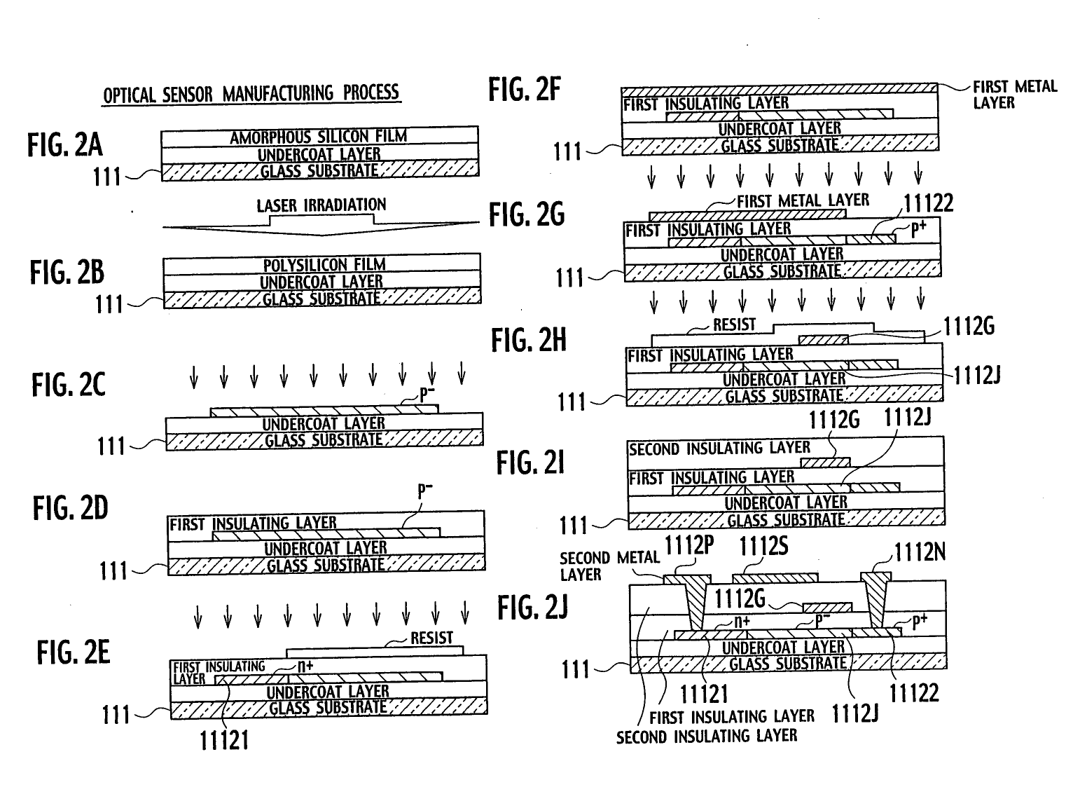

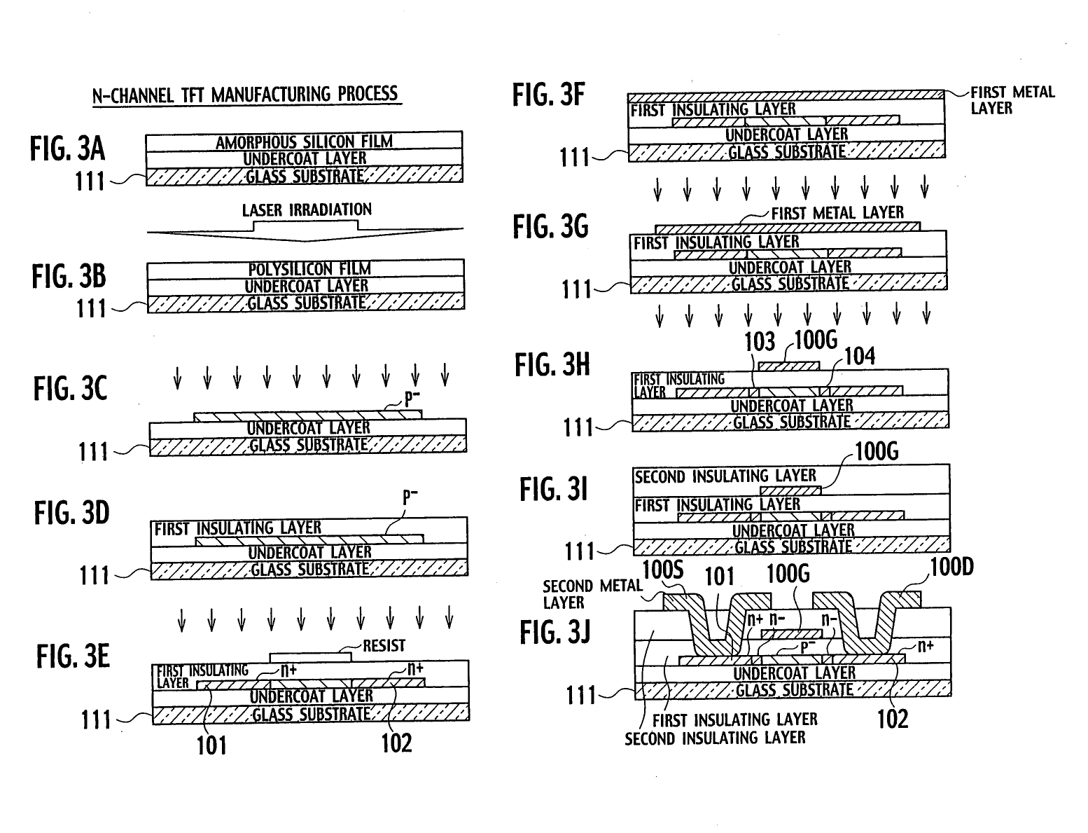

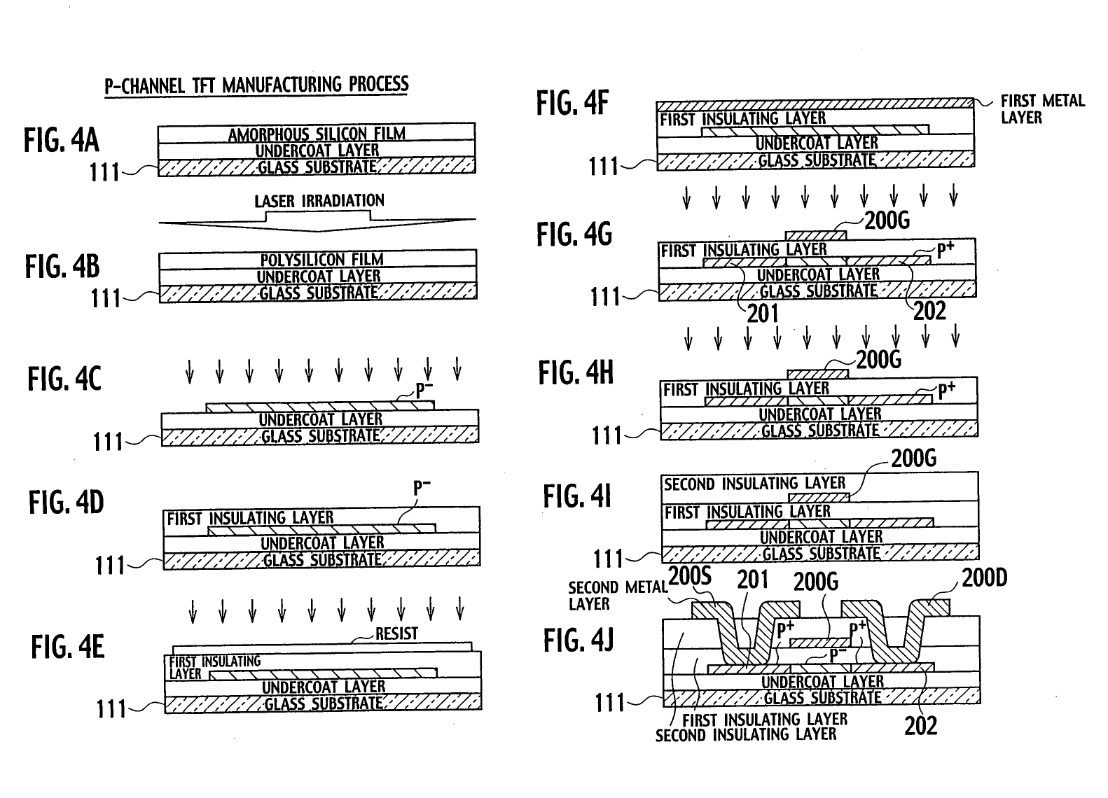

FIGS. 2A to 4J show a series of processes for forming, on the array substrate 11, the optical sensors 1112, n-channel TFTs 100 serving as the switching elements 1111, and p-channel TFTs 200 that form a drive circuit. These processes may involve a polysilicon process. Among FIGS. 2A to 4J, FIGS. 2A to 2J show a part of the array substrate 11 where the optical sensor 1112 is formed, FIGS. 3A to 3J show a part of the array substrate 11 where the n-channel TFT 100 is formed, and FIGS. 4A to 4J show a part of the array substrate 11 where the p-channel TFT 200 is formed.

Now, the series of processes for forming the optical sensors 1112, n-channel TFTs 100, and p-channel TFTs 200 on the array substrate 11 will be explained.

In FIGS. 2A, 3A, and 4A, an undercoat layer is formed on a glass substrate 111 from SiNx (silicon nitride) or SiOx (silicon oxide) by CVD (chemical vapor deposition). The undercoat layer prevents impurities such as phosphor and boron from diffusing to the glass substrate 111. Over the undercoat layer, amorphous silicon is deposited to about 50 angstroms by PECVD (plasma enhanced chemical vapor deposition) or spattering, to form an amorphous silicon film.

In FIGS. 2B, 3B, and 4B, a laser beam is emitted to the amorphous silicon film, to crystallize the amorphous silicon film into a polysilicon film.

In FIGS. 2C, 3C, and 4C, low-concentration boron ions are implanted into the whole surface of the polysilicon film. A mask is formed on the polysilicon film, and the polysilicon film is exposed and etched to form a p⁻ layer.

In FIGS. 2D, 3D, and 4D, an SiOx film serving as a first insulating layer is formed by, for example, PECVD.

In FIGS. 2E, 3E, and 4E, a resist mask is formed, and high-concentration phosphor ions are implanted into an n-type electrode region 11121 of each optical sensor 1112 and a source region 101 and drain region 102 of each n-channel TFT 100, to form an n⁺ layer.

In FIGS. 2F, 3F, and 4F, the resist mask is removed, and a first metal layer is formed over the first insulating layer from an Mo (molybdenum)-Ta (tantalum) alloy, an Mo—W (tungsten) alloy, or the like.

In FIGS. 2G, 3G, and 4G, the semifinished product is patterned to open a p-type electrode region 11122 of each optical sensor 1112 and a source region 201 and drain region 202 of each p-channel TFT 200. Then, high-concentration boron ions are implanted into the semifinished product.

At this time, the first metal layer serves as a mask to form a p⁺ layer in the p-type electrode region 11122, source region 201, and drain region 202. For the p-channel TFT 200, the first metal layer patterned at this time forms a gate electrode 200G.

In FIGS. 2H, 3H, and 4H, the first metal layer is patterned to open a light receiving part 1112J of each optical sensor 1112 and an n⁻ region 103 and n⁻ region 104 of each n-channel TFT 100. For the n-channel TFT 100, the first metal layer patterned at this time forms a gate electrode 100G. For the optical sensor 1112, the first metal layer patterned at this time forms a gate electrode 1112G.

A resist mask is formed over the optical sensors 1112, and low-concentration phosphor ions are implanted.

With the first metal layer and resist serving as a mask, an n⁻ layer is formed in the n⁻ region 103 and n⁻ region 104 of each n-channel TFT 100.

The light receiving part 1112J of the optical sensor 1112 is made of a p⁻ layer, and therefore, the optical sensor 1112 is a PIN-type optical sensor.

The resist mask is removed. To activate the implanted ions, the semifinished product is annealed at about 500° C. and is exposed to hydrogen plasma for hydrogenation.

In FIGS. 2I, 3I, and 4I, a second insulating layer is formed over the first insulating layer from SiOx by, for example, CVD.

In FIGS. 2J, 3J, 4J, contact holes are formed to expose the n-type electrode region 11121 and p-type electrode region 11122 of each optical sensor 1112, the source region 101 and drain region 102 of each n-channel TFT 100, and the source region 201 and drain region 202 of each p-channel TFT 200. The exposed parts are covered with a second metal layer, which is patterned to form the p-type electrode 1112P, n-type electrode 1112N, and light shield band 1112S of each optical sensor 1112, the source electrode 100S and drain electrode 100D of each n-channel TFT 100, and the source electrode 200S and drain electrode 200D of each p-channel TFT 200.

Returning to FIG. 1, a display operation of the LCD 1 will be explained.

In the LCD 1, the scanning lines are sequentially driven and switching elements 1111 corresponding to, for example, red (R) pixels to be written with a selected scanning line are driven to be conductive. Then, a video signal supplied to the signal lines is applied to the pixel electrodes 113 of the selected red pixels. At the same time, a predetermined signal is supplied to each of the reflective electrode 135 and transparent electrode 134a. This results in applying an electric field to the liquid crystal layer 12 between the pixel electrodes 113 and the reflective electrode 135 and transparent electrode 134a. The strength of the electric field is dependent on the amplitude of the video signal and influences the light transmittance of the liquid crystal layer 12.

Part of the light emitted from the light source 14 to the transmissive display area A is sequentially transmitted through the polarizing plate 13A, glass substrate 131, color filter 132, transparent resin layer 133, transparent electrode 134a, orientation film (not shown), liquid crystal layer 12, orientation film (not shown), pixel electrodes 113, transparent resin layer 112, glass substrate 111, and polarizing plate 11A and is emitted to the outside.

External light made incident to the reflective display area B is sequentially transmitted through the polarizing plate 11A, glass substrate 111, transparent resin layer 112, pixel electrodes 113, orientation film (not shown), liquid crystal layer 12, and orientation film (not shown) and reaches the reflective electrode 135. The light is reflected from the reflective electrode 135, is sequentially transmitted through the orientation film (not shown), liquid crystal layer 12, orientation film (not shown), pixel electrodes 113, transparent resin layer 112, glass substrate 111, and polarizing plate 11A, and is emitted outside. The reflective electrode 135 has irregularities, and therefore, the reflected light from the reflective electrode 135 scatters.

By controlling the light transmittance of the liquid crystal layer 12, the LCD 1 can control the intensity of light emitted from the liquid crystal layer 12, i.e., the brightness of the pixels to display characters and images.

Scattering the reflected light from the reflective electrode 135 with the irregularities of the reflective electrode 135 can widen a view angle.

The reflective electrode 135 is arranged on the liquid crystal layer 12 side of the color filter 132, so that external light is not transmitted through the color filter 132. As a result, the reflective display area B can display a monochromatic image.

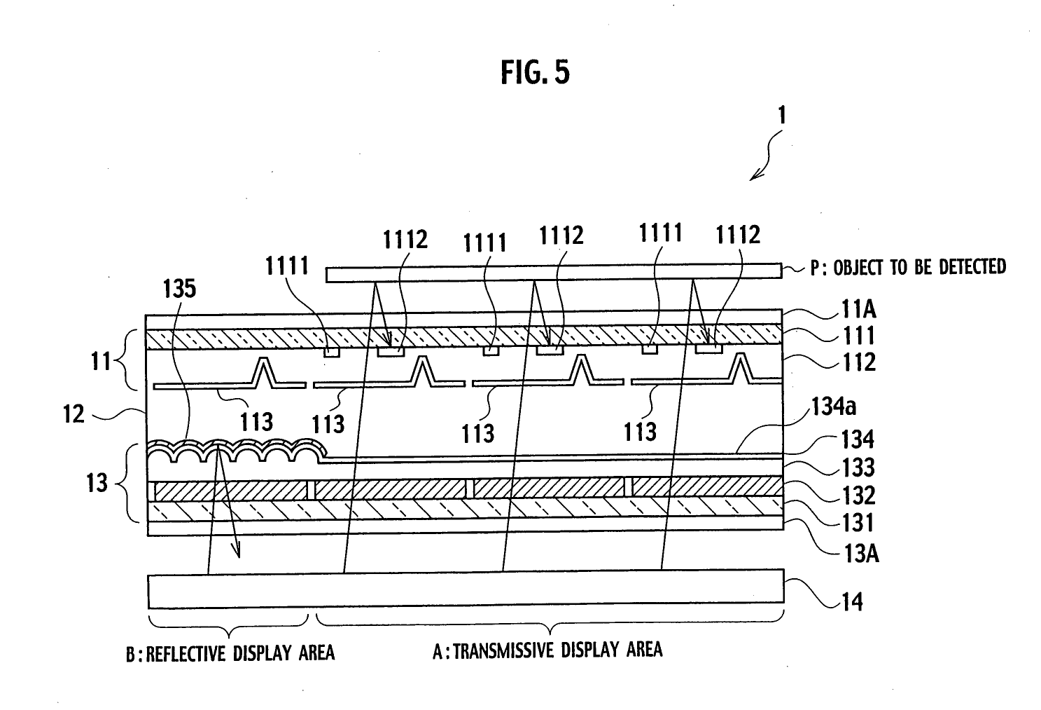

With reference to FIG. 5, which is a sectional view similar to FIG. 1, a detective operation of the LCD 1 will be explained.

An image signal that has been controlled to equalize the light transmittance of the liquid crystal layer 12 in the transmissive display area A is supplied to the signal lines. Thereafter, an object P such as a printed object to be detected is positioned in front of the transmissive display area A of the array substrate 11.

Light emitted from the light source 14 is transmitted through the polarizing plate 13A, glass substrate 131, and color filter 132. Part of the light transmitted through the color filter 132 and reflective display area B is transmitted through the transparent resin layer 133 and is reflected from the reflective electrode 135.

The remaining part of the light transmitted through the color filter 132 is sequentially transmitted through the transparent resin layer 133, transparent electrode 134a, orientation film (not shown), pixel electrodes 113, transparent resin layer 112, glass substrate 111, and polarizing plate 11A and is transmitted outside. Then, this light is reflected from the detection object P and enters the array substrate 11. The intensity of the entered light is converted by each optical sensor 1112 into an electronic signal, which is detected by the detective circuit and is used to form an image of the object P.

As mentioned above, the array substrate 11 of the LCD 1 has the optical sensors 1112 serving as detective elements to detect light from a detection object that is presented in front of the array substrate 11. The counter substrate 13 has the color filter 132 to transmit light emitted from the light source 14, the transparent electrode 134a that faces some pixel electrodes 113 and passes the light transmitted through the color filter 132, and the reflective electrode 135 that faces the remaining pixel electrodes 113 and reflects external light. With this arrangement, light from the detection object is directly given to the optical sensors 1112 serving as detective elements and is properly used to provide a correct image of the object. The light emitted from the light source 14 and transmitted through the transparent electrode 134a and the external light reflected from the reflective electrode 135 are both transmitted through the liquid crystal layer 12, to realize transmissive display and reflective display.

The reflective electrode 135 has irregularities to scatter light reflected from the reflective electrode 135, thereby widening the view angle.

The reflective electrode 135 is arranged on the liquid crystal layer 12 side of the color filter 132 to prevent external light from entering the color filter 132. Namely, the reflective electrode 135 realizes monochromatic reflective display.

In the LCD 1 according to this embodiment, the optical sensors 1112 are provided for the pixels in the transmissive display area A, respectively. Instead, the optical sensors 1112 may be provided for the pixels in the reflective display area B, respectively. Alternatively, the optical sensors 1112 may be provided for the pixels in the transmissive display area A and reflective display area B, respectively. It is also possible to regularly arrange the optical sensors 1112 in a predetermined detective area in the array substrate 11. The optical sensors 1112 are not limited to the PIN-type sensors. Any other type, for example, PN-type optical sensors are acceptable for the present invention.

In the LCD 1 according to the present invention, the optical sensors 1112 may detect the intensity of light emitted from a light pen to allow pen input. Instead of the optical sensors 1112, piezoelectric elements may be employed as pressure detecting elements to realize a touch panel function. The piezoelectric elements provided for the array substrate 11 can correctly detect objective pressure.

When detecting light from a light pen or pressure from an object, the optical sensors 1112 or piezoelectric elements may be arranged outside the display area of the array substrate 11.

What is claimed is:

1. A liquid crystal display comprising an array substrate provided with a plurality of scanning lines and a plurality of signal lines that cross the scanning lines, a counter substrate, a liquid crystal layer held between the array substrate and the counter substrate, and pixels formed at crossing portions of the scanning lines and the signal lines, respectively, wherein:
the array substrate includes transparent pixel electrodes and detective elements, the pixel electrodes being provided for the pixels, respectively, to apply an electric field to the liquid crystal layer, the detective elements detecting an object presented in front of the array substrate; and
the counter substrate includes a color filter to transmit light emitted from a light source that is arranged behind the counter substrate, a transparent electrode facing a first plurality of the pixel electrodes, to transmit the light transmitted through the color filter, and a reflective electrode facing a second plurality of the pixel electrodes, to reflect external light.

2. The liquid crystal display of claim 1, wherein the reflective electrode has irregularities.

3. The liquid crystal display of any one of claims 1 and 2, wherein the reflective electrode is arranged on the liquid crystal layer side of the color filter.
